(19) United States
(12) Patent Application Publication
(10) Pub. No.: US 2011/0216283 A1
(43) Pub. Date: Sep. 8, 2011

(54) CONNECTING AND EXCHANGE SYSTEM, PREFERABLY BETWEEN EYEGLASS TEMPLE PIECES AND EYEGLASS FRONT

(76) Inventor: Andreas Dünnbier, Leonberg (DE)

(21) Appl. No.: 13/013,210

(22) Filed: Jan. 25, 2011

(30) Foreign Application Priority Data
Mar. 4, 2010 (DE) 102010010267.9

(51) Int. Cl. G02C 5/00

(52) U.S. Cl. 351/140

(57) ABSTRACT

A connection and changing system, primarily between the spectacle temple and spectacle front. The temple and front components of the frame can be joined and then separated again as often as required.

The invention pertains to a connection and changing system, primarily between the spectacle temple and spectacle front. The temple and front components of the frame can be joined and then separated again as often as required.

In systems used, straight hooks among others are used for connecting the connector and coupling. That is why there is often no accuracy of fit between the connector and the coupling, there is a gap. This instability causes dissatisfaction when using the connecting elements.

The function of the invention is to create a positive-fit connection of two parts that can be changed, primarily spectacle temple and spectacle front. Different temples should be able to be changed simply according to customer specification.

The invention removes the instability and therefore guarantees operational convenience. The connection is achieved by inserting and firmly pulling out the pyramid-shaped connector with gaps and the suitable coupling.

Primarily for spectacle temple and spectacle front.

The invention pertains to a connection and changing system, primarily between the spectacle temple and spectacle front. The temple and front components of the frame can be joined and then separated again as often as required.

For spectacle temple and spectacle front, several systems are recognised for achieving such a flexible and simple separation and connection with flat objects.

The European patent EP 1156358B1 pertains to a fastening system for spectacles, which at the same time makes the spectacle lenses and the spectacle temple interchangeable. In the protective letter DE 4219038, a spectacle frame with detachable temples is represented. The spectacle temple is released by overstretching the position of the temple. A further recognised invention is pertained to in the US patent 2005/0280771A1. On the spectacle front, two straight coupling lugs are fitted on each side. The spectacle front is pushed with said coupling lugs into the holding device. Thus the hooks are pushed together. When these hooks reach the designated position, they click into place in the coupling. Indentations are present in the coupling which the hooks fit into. To release, the hooks must be pushed down and at the same the connector must be pulled out of the coupling.

The basic idea behind all these designs is that interchangeable systems for spectacles are necessary. This also against the backdrop of the flexible changing of colours and designs of the spectacles.

In connecting two components under the restriction of a flat construction, such as glasses frames, there are many disadvantages with the recognised designs. With some designs, separating the spectacle temple from the spectacle front is only possible with the help of technical tools. Furthermore, several systems require considerable dexterity. Small hooks must be pushed. These fine motor skills are not always affordable or wanted for spectacle wearers. With the systems used, straight hooks are used for connecting the connector and the coupling. For reasons to do with production, inaccuracies of fit arise in mass production. That is why often no accuracy of fit is reached between the connector and the coupling, as there is a gap. This instability causes dissatisfaction when using the connecting elements.

The function of the invention is to create a positive-fit connection of two parts that can be changed, primarily spectacle temple and spectacle front. Different temples should be able to be changed simply according to customer specification.

This function must be achieved for very flat connection elements and for twist stability at the same time.

The invention removes the instability and therefore also guarantees operational convenience. The connection is achieved by inserting and firmly pulling out the pyramid shaped connector with columns and the suitable coupling.

Metal processed with Nym technology is the favoured material used for the connection and changing system. Due to the fineness of the connection is it necessary that the sleeve surrounds the spectacle temple and the spectacle front at the entrance point in order to guarantee the guiding of the connector and coupling.

A flat construction is possible. The invention makes used of the fact that a best possible accuracy of fit is achieved through positive-fit connections of super imposing pyramids.

Inaccuracies related to production are thereby removed as the connector is pushed into the coupling up to the point of form closure. Tolerances are counterbalanced through the interaction of the ridge and the indentation, since a constant force in the connector pulls in the direction of the coupling. The tension force is restricted by the end of the sleeve.

A very simple changing system which is suitable for mass production can thereby be achieved that a flat connector with gaps and an opposite lying coupling are connected. Since the connection when connected only has an effect against traction, the lateral forces which have an effect on the connection system are absorbed by the sleeve.

This sleeve joins the coupling and connector together as the pyramid stump on the connector is inserted with positive locking into the end of the sleeve of the temple. Due to the fact that the ridge is located slightly displaced at the centre of the indentation when closed, the forward flank of the ridge is pushed at an angle against the indentation due to the spring force of the tongue. This lasting traction results in a constant positive-fit connection between the connector and the coupling.

So that the connector is easier to move in than it is to move out, the angle at the end of the gap on the connector head is smaller than the angle at the end of the gap on the indentation when pulling out.

### PARTS LIST

1 Spectacle front
2 Spectacle temple
3 Connector
4 Coupling
5 Pyramid-shaped connector
6 Gap
7 Indentation
8 Ridge
9 Tongue
10 Angle on the tongue when pushing in
11 Angle on the indentation when pulling out
12 Form closure connector and coupling
13 Contact pressure ridge
14 Sleeve
15 Restriction of the sleeve and the end point of the sleeve
16 Angle on the indentation

The following drawings represent a design example for the connecting and changing system for spectacle temples and fronts.

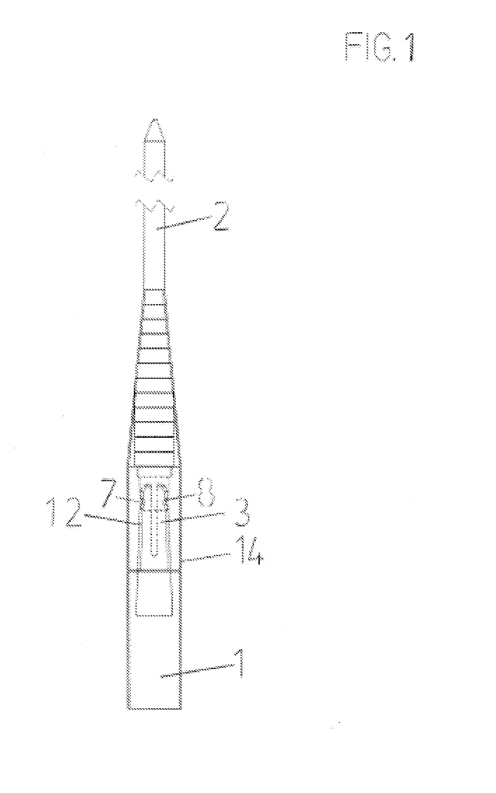

FIG. 1.

Shows the top view of spectacle temple 2 and spectacle front 1 when connected.

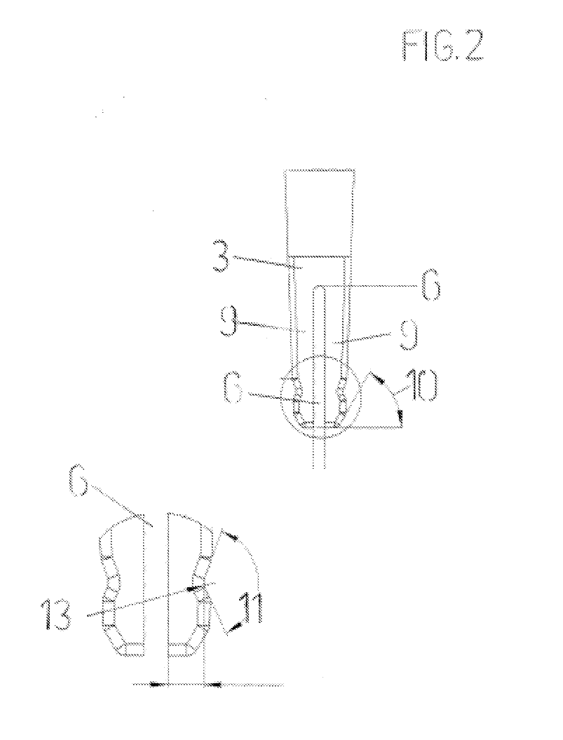

FIG. 2.

Shows the top view of the pyramid-shaped connector 5 with gap 6 as well as the detailed drawing of the connector head.

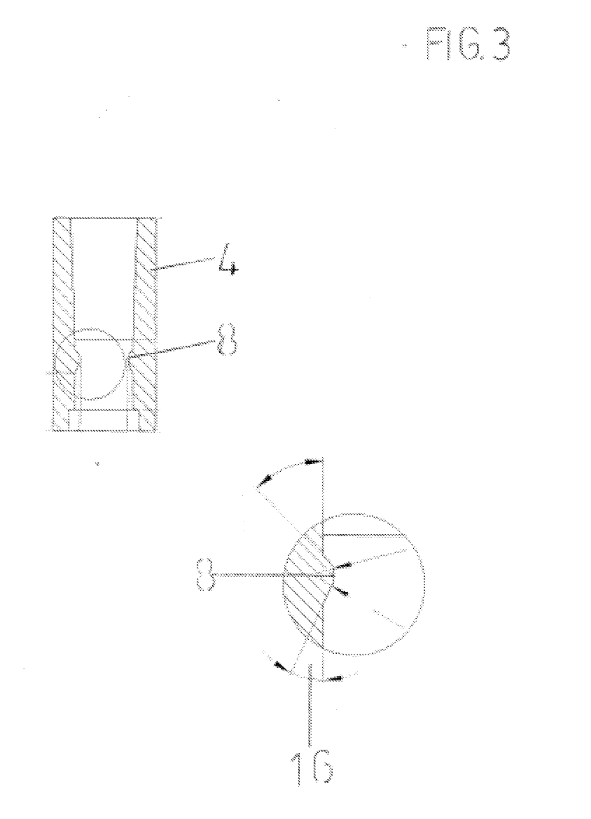

FIG. 3.

Shows the top view of the pyramid-shaped coupling 4 as well as the detailed drawing of the ridge 8 on the coupling 4.

When connected, sleeve 14 of temple 2 is in a positive-fit connection with spectacle front 1. Equally connector 3 is surrounded with positive locking by the sleeve 12. Ridge 8 is clicked into indentation 7.

To FIG. 2.

Connector 3 is divided into two parts with the two tongues 9. Gap 6 is open. Flat angle 10 which pushes the tongue when inserting is flatter than the angle on indentation 11 when pulling out connector 3 from coupling 4. Contact pressure point 13 is indicated for the ridge.

To FIG. 3.

In coupling 4, ridge 8 protrudes into free space. For attaching the tongues a flat angle 16 is installed on the ridge.

1. Connection and changing system, primarily for the connection of spectacle temples and spectacle fronts, consists of a connector and a coupling.
characterised in that
the connector is pyramid-shaped
the connector has an oblong gap
the connectors has an indentation for clicking in and out of place at the front end
a ridge is located in the coupling which inserts into indentation.

2. Connection system according to claim 1
characterised in that
both tongues of the connector are flexible.

3. Connection system according to claim 1
characterised in that
the angle on the tongue when pushing the connector into the coupling at the beginning of the connector is less steep that the angle on the indentation when pulling out.

4. Connection system according to claim 2
characterised in that
the angle of the ridge when pushing the tongues together is steeper that when pulling out the tongue

5. Connection system according to claim 1
characterised in that
the connector is pushed into the coupling with a positive locking

6. Connection system according to claim 1
characterised in that
that when the connector is fully inserted into the coupling the ridge obliquely or transversely pushes on the sides of the indentation.

7. Connection system according to claim 1
characterised in that
a sleeve surrounds and guides the connector and the coupling

8. Connection system according to claims 1 and 7
characterised in that
the sleeve restricts the insertion depth of the connector in the coupling.
